(19) United States
(12) Patent Application Publication
(10) Pub. No.: US 2026/0054943 A1
(43) Pub. Date: Feb. 26, 2026

(54) UNIT AND METHOD FOR TRANSFERRING ARTICLES

(71) Applicant: R.A JONES & CO., Covington, KY (US)

(72) Inventors: Andrea BIONDI, Bologna (IT); Luca CAVAZZA, Bologna (IT); Antonio GIGANTE, Bologna (IT)

(73) Assignee: R.A JONES & CO., Covington, KY (US)

(21) Appl. No.: 19/102,374

(22) PCT Filed: Aug. 3, 2023
(86) PCT No.: PCT/IB2023/057845

§ 371 Date: Feb. 8, 2025

(30) Foreign Application Priority Data
Aug. 10, 2022 (IT) 102022000017118
Aug. 10, 2022 (IT) 102022000017121

(51) Int. Cl. B65G 47/90; B65G 47/53

(52) U.S. Cl. CPC B65G 47/902; B65G 47/53; B65G 47/907

(57) ABSTRACT

A transfer unit for transferring articles includes: a first transfer element with a first support structure and a first abutment structure for a first article; a second transfer element with a second support structure and a second abutment structure for a second article; a conveyor adapted to receive said first and second articles from the first and second transfer elements; a rotation unit configured to rotate the first and second support structures about respective rotation axes from a support configuration in which the first and second articles are supported by the support structures, to a discharge configuration in which the first and second articles are free to fall from the transfer elements onto the conveyor. In the support configuration, the support structures are inclined with respect to a horizontal plane so as to ease the movement of the first and second articles respectively towards the abutment structures

### CROSS REFERENCE TO RELATED APPLICATIONS

This application is a § 371 National Phase of PCT/IB2023/057845, filed Aug. 3, 2023, which claims priority of Italian Patent Applications Nos. 1020220000117118 and 102022000017121, filed Aug. 10, 2022, the entire contents of all of which are incorporated by reference herein as is fully set forth.

### FIELD OF THE INVENTION

The present invention relates to a unit and a method for transferring articles. The invention finds preferred, even if not exclusive, use in the transfer of articles into an apparatus for packaging articles in boxes, particularly suitable for packaging articles in accordance with a process in which the box is formed by folding a pre-formed blank. The invention also finds preferred, though not exclusive, application in the transfer of articles of variable geometry, such as bags containing loose material, or flowable material.

Therefore, reference will be made hereinafter to such a sector without thereby losing generality.

### BACKGROUND

In particular, in the relevant technical field, it is known to package articles inside a box according to a process which provides to prepare the articles to be packaged in a preparation unit and then transfer such articles to a packaging unit so that they can be packaged in boxes. The packaging in boxes can occur in a number of distinct modes. A first mode envisages a first step of forming a box, open at least at one end thereof, the subsequent insertion of the article to be packaged into the open box and, then, the closure of the open end. In a second mode, the box is formed by wrapping a blank around a mandrel which is made of a rigid material, e.g., metal, and which contains the article to be packaged.

In the present description as well as in the accompanying claims, some terms and expressions are deemed to assume, unless otherwise expressly indicated, the meaning expressed in the following definitions.

The term ‘article’ refers to any product which can be handled and moved by means of appropriate movement devices. In particular, in the present description the term ‘article’ is intended as any product which can be packaged in boxes. The articles can have a predefined geometric shape, or they can have a variable geometry. Preferably, the articles are food and confectionery articles, either loose or contained inside bags or other types of wrapping. In particular, the term articles is used in the present description to refer to bags, or similar containers, made of flexible material enclosing therein loose, or flowable, material within the bag. For example, the articles can comprise bags of grains, individual chocolates (wrapped or unwrapped), candies, pouches containing solid, liquid or semi-solid food articles; also, absorbent articles for hygienic use, articles from the tobacco industry, articles from the cosmetics industry, articles from the pharmaceutical industry, articles from the ‘personal & home care’industry.

‘Flowable material’ or ‘loose material’ is intended as material in pieces such as flakes, granules, or powder, or gel. In some versions, the flowable material can also be formed by a single piece of flexible material of variable geometry.

The term ‘transport direction’ is intended as the direction along which an object, e.g., an article, is transported. The transport direction is represented by an oriented line. When a direction, or a section thereof, are comprised within a plane, such a plane is defined as the ‘transport plane’of the object.

With reference to a particular transport direction, a first element has an ‘advanced position’, or is defined as ‘advanced’, or is positioned ‘downstream’ with respect to a second element when along the oriented line identified by such a transport direction, the first element is located in a position subsequent to the position of the second element. Similarly, a ‘backward position’ or an ‘upstream’ position of a first element with respect to a second element is also defined when, along the oriented line identified by the direction, the first element is in a preceding position with respect to the position of the second element.

A vector quantity, e.g., speed, is defined by a ‘modulus’ and by a ‘direction’, intended herein to comprise also the direction, and can be represented by an oriented segment of length equal to the ‘modulus’ and oriented in the direction indicated by the ‘direction’.

A ‘support structure’ is a structure which allows to support an article, preventing the falling thereof. A support structure can consist of a single continuous element, or of a perforated element such as a grid, or even of a plurality of elements which are also continuous or perforated, e.g., comb-shaped. The support structure can also consist of a plurality of fixed elements or even a plurality of moving elements, such as a plurality of rollers or balls. The elements of the plurality of elements forming the support structure are shaped so that the spaces between two contiguous elements, or between two contiguous holes in the grid, are such as to prevent the passage of the article therethrough, so as to support the article.

In the context of the present description, a support plane is intended as a surface designed to support the article without necessarily being flat; a support surface could also be curved, e.g., corrugated or concave.

An article is ‘supported’ by a component of the transfer unit, when the component is in contact with the article and prevents the falling thereof. It should be specified that the support of the article does not in itself imply that the article is in contact over its entire surface with a component of the transfer unit, but it is sufficient that there is contact between the component and the article on one portion of the same article such as to prevent a fall of the article. It is also sufficient that at least one portion of the component of the transfer unit is in contact with the article so as to support it

An “abutment structure” can consist of a single continuous element, or of a perforated element such as a grid, or even of a plurality of elements which are also continuous or perforated, e.g., comb-shaped. The abutment structure can also consist of a plurality of fixed elements or even a plurality of moving elements, such as a plurality of rollers or balls. The elements of the plurality of elements forming the abutment structure are shaped so that the spaces between two contiguous elements, or between two contiguous holes in the grid, are such as to prevent the passage of the article therethrough.

In the context of the present description, an abutment plane is intended as a surface designed to abut the article without necessarily being flat; an abutment surface could also be curved, e.g., corrugated or concave.

In particular, an article is ‘abutted’ by a component of the transfer unit when the component is in contact with the article and prevents the movement thereof in at least one direction. It should be specified that the abutment of the article does not in itself imply that the article is in contact over its entire surface with a component of the transfer unit, or conversely that an entire surface of the component of the transfer unit is in contact with the article, but it is sufficient that there is contact between the component and the article on a portion of the article itself and/or of the component of the transfer unit.

A ‘station’ indicates an operating position defined within a packaging process or in a packaging apparatus.

Two elements are positioned ‘adjacent’ to each other or are ‘adjacent’ when they are placed side by side without contact therebetween.

The Applicant first observed that a packaging process in which the article to be packaged is prepared in a preparation unit independent of the packaging unit and subsequently fed to the packaging unit allows to obtain significant advantages in terms of flexibility with respect to a packaging process in which the article to be packaged is prepared in the same packaging unit which is then intended to package the article in the box. Operating with the latter mode, it is in fact necessary to coordinate the article preparation operations with the packaging operations. Conversely, preparing the article in a separate preparation unit, it is possible to eliminate or limit the repercussions of any malfunctions in the preparation unit on the operation of the packaging unit, or vice versa.

For this purpose, the Applicant has noted that the articles, after having been pre-assembled if necessary, are loaded onto a feed belt and fed by means of the feed belt to a conveyor of the packaging unit.

The Applicant has verified that it is necessary for the articles to be positioned in a certain deposit position on the conveyor because the position of the articles on the conveyor influences the subsequent handling operations packaging the articles. The Applicant has noted that such a need is particularly evident when two or more articles are to be packaged in the same box. In such a case, in fact, greater precision is required in the positioning on the conveyor of the articles to be packaged in the same box.

However, the Applicant has found that it is not possible to precisely adjust the position of the articles on the conveyor.

In particular, the Applicant has observed that the most critical steps in the transfer process, during which the greatest misalignment of articles can occur, are the positioning of the articles on the feed belt and the passage of the articles from the feed belt to the conveyor.

The Applicant has verified that for space optimization reasons, the feed belt is positioned perpendicular to the conveyor and that the outlet section of the feed belt is placed at a greater vertical height with respect to the conveyor and misaligned with respect to the desired deposit position for the article on the conveyor. Therefore, the articles are ejected from the feed belt at a certain speed so that they have a parabolic falling trajectory on the conveyor and fall onto the conveyor at the desired deposit position. The speed of the articles in output from the feed belt depends on the movement speed of the feed belt.

The Applicant has verified that as the feed speed increases, it is more difficult to precisely adjust the deposit position of the article on the conveyor.

The Applicant has therefore imagined using alternative transfer systems, e.g., reducing the movement speed of the feed belt, so as to facilitate the correct positioning of the articles on the conveyor. However, the Applicant has found that such a possibility was not only difficult to implement because it was not compatible with the high speeds required for the packaging process, but also did not allow to obtain the desired advantages in terms of correct positioning of the articles on the conveyor.

The Applicant therefore imagined reducing the trajectory of the article in the passage from the feed belt to the conveyor by using transfer systems having a support tray intended to receive the article from the feed belt and deposit it on the conveyor, in which the tray is positioned at the deposit position of the conveyor and at a greater vertical height of the conveyor and almost corresponding to that of the feed belt outlet.

However, the Applicant has verified that even such an embodiment did not allow to completely eliminate the problem of incorrect positioning of the articles on the conveyor because it did not allow to compensate for any incorrect positioning of the articles on the feed belt.

In fact, the Applicant has verified that with such a transfer system, incorrect positioning on the feed belt was reflected in an incorrect positioning of the articles on the tray and thus on the conveyor.

The Applicant therefore realized that in order to improve the positioning of the articles on the conveyor it was necessary to rethink the transfer unit.

The Applicant realized that in order to correctly position an article on a conveyor, the position of the article on the transfer element had to be precisely adjusted.

The Applicant thus perceived that using a transfer element having a support structure shaped so as to support an article in a certain portion thereof would allow to increase the accuracy of the positioning of the article on the conveyor. The Applicant therefore perceived that using a transfer element having an inclined support structure with respect to a horizontal plane so as to favor the movement of the article on the support structure towards a desired zone thereof, it was possible to circumscribe the zone of the support structure on which the article could be positioned and, therefore, to adjust the positioning of the article on the transfer element. The Applicant has verified that this allowed the article to be deposited in the desired storage position on the conveyor.

The Applicant has finally found that a method and unit for transferring articles which provides to use a transfer element comprising a support structure defining a support plane and an abutment structure defining a transverse abutment plane with respect to the support plane and in which the transfer element can be configured in a support configuration in which the transfer element is intended to receive an article and in which the support structure is inclined with respect to a horizontal plane so as to ease the movement of the article towards the abutment structure, it was possible to adjust the positioning of the article on the transfer element and thus deposit it in the desired storage position on the conveyor.

Therefore, in a first aspect thereof, the invention relates to an article transfer unit.

Preferably, the transfer unit comprises a first transfer element provided with at least a first support structure defining a first support plane.

Preferably, the transfer unit comprises a first abutment frame defining a first abutment plane which is inclined with respect to the first support plane.

Preferably, said first abutment structure cooperates with said first support structure to define a housing seat for a first article.

Preferably, the transfer unit comprises a second transfer element provided with at least a second support structure defining a second support plane.

Preferably, the transfer unit comprises a second abutment frame defining a second abutment plane which is inclined with respect to the second support plane.

Preferably, said second abutment structure cooperates with said second support structure to define a housing seat for a second article.

Preferably, the transfer unit comprises a conveyor adapted to receive said first article from said first transfer element and said second article from said second transfer element.

Preferably, the conveyor is positioned at a lower vertical height with respect to said first support structure and said second support structure.

Preferably, the transfer unit comprises a rotation unit configured to rotate said first support structure about a first rotation axis from a support configuration in which said first article is supported by said first support structure to a discharge configuration in which said first article is free to fall from said first transfer element onto said conveyor.

Preferably, the rotation unit is configured to rotate said second support structure about a second rotation axis from a support configuration in which said second article is supported by said second support structure to a discharge configuration in which said second article is free to fall from said second transfer element onto said conveyor.

Preferably, in said support configuration said first support structure is inclined with respect to a horizontal plane so as to ease the movement of said first article towards said first abutment structure.

Preferably, in said support configuration said second support structure is inclined with respect to a horizontal plane so as to ease the movement of said second article towards said second abutment structure.

In a second aspect thereof, the invention relates to a method for transferring articles on a conveyor.

Preferably the method comprises arranging a first transfer element provided with at least a first support structure defining a first support plane and with a first abutment structure defining a first abutment plane which is transverse with respect to the first support plane, and cooperating with said first support structure to define a housing seat for a first article.

Preferably the method comprises arranging a second transfer element provided with at least a second support structure defining a second support plane and with a second abutment structure defining a second abutment plane which is transverse with respect to the second abutment structure, and cooperating with the second support structure to define a housing seat for a second article.

Preferably, the method comprises positioning said first transfer element in a support configuration in which said first support structure is inclined with respect to a horizontal plane so as to ease the movement of said first article towards said first abutment structure.

Preferably, the method comprises positioning said second transfer element in a support configuration in which said second support structure is inclined with respect to a horizontal plane so as to ease the movement of said second article towards said second abutment structure.

Preferably the method comprises feeding said first article and said second article on said first support structure and said second support structure, respectively.

Preferably the method comprises rotating said first support structure about a first rotation axis and said second support structure about a second rotation axis from said support configuration in which said first article and said second article supported by said first support structure and said second support structure, respectively, to a discharge configuration in which said first article and said second article are free to fall respectively from said first transfer element and said second transfer element onto a conveyor lying below the first transfer element and the second transfer element.

In a third aspect of the invention, an apparatus for packaging articles in boxes is provided, comprising a transfer unit according to the first aspect of the invention and a preparation unit for preparing and feeding said first article and said second article to said transfer unit.

Thanks to these features, the method and the transfer unit according to the present technical solution allow articles to be correctly positioned on a conveyor independently of the position of the articles on the feed belt, moreover without penalizing production speed. Thanks to these features, it is also possible to compensate for any misalignment or incorrect positioning of the articles on the feed belt by precisely positioning the articles on the conveyor.

By providing a transfer element with an inclined support structure, it is possible to cause the article to move towards the abutment structure, whereby, regardless of which zone of the support structure the article is fed onto, the latter will move towards a certain zone of the support structure. It is thus possible to adjust the position of the article on the transfer element and deposit the article in a desired storage zone on the conveyor.

This further allows two separate articles to be correctly positioned on the transfer unit, preventing them from overlapping each other and/or being too close to each other. Therefore, it is possible to effectively transfer two articles at the same time. It is possible to improve the positioning accuracy of articles on the conveyor.

Such advantages are obtained without the need to reduce the conveyor speed and thus the productivity of the packaging unit.

The first and the second transfer element are positioned in the transfer unit so as to be able to rotate or moved them without hitting each other.

The present invention, in at least one of the aforesaid aspects, may have at least one of the further preferred features set forth below.

Preferably, the first abutment structure extends from said first support structure so as to define a housing seat open upwards.

Preferably, the second abutment structure extends from said second support structure so as to define a housing seat open upwards. This allows to at least partially use the action of gravity to feed the article into the housing seat. In fact, it is possible to feed the article into the housing seat from above so that the positioning of the article in the housing seat and in particular on the first support structure is eased by the action of the force of gravity. This facilitates the positioning of the article in the housing seat.

In some versions, the first support structure comprises a first proximal edge arranged towards or adjacent to the first abutment structure and a first free edge opposite the first proximal edge.

Preferably in the support configuration, said first proximal edge is arranged at a first vertical height which is lower with respect to said first free edge.

In some versions, said first proximal edge is arranged parallel to said first rotation axis.

In some versions, the second support structure comprises a second proximal edge arranged towards or adjacent to the second abutment structure and a second edge opposite the second proximal edge.

Preferably in the support configuration, said second proximal edge is arranged at a second vertical height which is lower with respect to said second free edge.

In some versions, said second proximal edge is arranged parallel to said second rotation axis.

In some versions, at least one of said first proximal edge and said second proximal edge are arranged in a plane perpendicular to the first rotation axis or the second rotation axis, respectively.

Preferably said first free edge and said second free edge are positioned at the same vertical height.

In some versions in said support configuration, said first support structure is inclined with respect to the horizontal plane by a first angle of inclination of at least 10°, preferably between about 20°and about 50°, most preferably about 30°.

In some versions in said support configuration, said second support structure is inclined with respect to the horizontal plane by a second angle of inclination of at least 10°, preferably between about 20°and about 50°, most preferably about 30°.

The angle of inclination of the first and/or second support structure is chosen based on the features of the first and/or second article to be transferred.

Preferably the first support structure and the second support structure are inclined at the same angle of inclination with respect to the horizontal plane.

Preferably in said support configuration said first support structure and said second support structure are adjacent to each other and said first abutment structure and said second abutment structure are positioned on opposite sides with respect to said first support structure and said second support structure. Thereby the first support structure and the second support structure are interposed between the first abutment structure and the second abutment structure. Said first support structure and said second support structure are arranged adjacent to each other but without contact, a desired distance being provided between the first and the second support structure. Thereby, the first and the second support structure can be rotated without touching each other. This distance can be adjusted based on the features and dimensions of the articles to be transferred.

In some versions, the first abutment structure is erected from the first support structure.

In some versions, the second abutment structure is erected from the second support structure.

The first abutment structure is preferably incident on the first support structure.

The second abutment structure is preferably incident on the second support structure. This thereby limits the possibility of any accidental dropping of the first and/or second article.

Preferably, the first abutment structure is extended from said first support structure in the opposite direction with respect to the conveyor.

Preferably, the second abutment structure is extended from said second support structure in the opposite direction with respect to the conveyor.

In some versions, the first abutment plane is inclined by a first angle comprised between about 85°and about 120°with respect to the first support plane, preferably about 90°.

In some versions, the second abutment plane is inclined by a second angle comprised between about 85°and about 120°with respect to the second support plane, preferably about 90°.

In some versions, at least one of said first support structure, said second support structure, said first abutment structure and said second abutment structure comprises a slab-like body with a substantially planar extension.

Preferably said rotation unit is configured to rotate said first transfer element between said support configuration and said discharge configuration with a rotation speed comprised between about 50 rad/sec and about 80 rad/sec, preferably about 70 rad/sec.

Preferably said rotation unit is configured to rotate said second transfer element between said support configuration and said discharge configuration with a rotation speed comprised between about 50 rad/sec and about 80 rad/sec, preferably about 70 rad/sec.

By varying the rotation speed of the first and/or second transfer element, it is possible to vary the thrust of the article on the conveyor and to vary the vertical component of the impact force of the article on the conveyor. It is possible to improve the positioning of the article on the conveyor and, above all, the distribution of the product flowable inside the bag. The Applicant has also found that by adopting the above-mentioned rotation speed values, a good positioning of the product in the bag is obtained without damaging the product. The optimal working conditions are chosen based on the features of the article to be deposited and/or the product contained therein so as not to compromise the integrity of the bags and/or the flowable product contained therein.

In some versions said rotation unit is configured to rotate said first transfer element along a first rotation direction to bring it from said support configuration to said discharge configuration and to rotate said second transfer element along a second rotation direction opposite the first rotation direction to bring it from said support configuration to said discharge configuration.

Preferably said rotation unit is configured to rotate said first transfer element and said second transfer element in a synchronized manner.

In some versions, said transfer unit comprises an actuation device configured to translate said first transfer element and said second transfer element between a first receiving station in which said first transfer element is arranged to receive said first article and a second receiving station in which said second transfer element is arranged to receive said second article.

In some versions, said transfer unit comprises an actuation device configured to translate said first transfer element and said second transfer element to a receiving station in which said first transfer element is arranged to receive said first article and said second transfer element is arranged to receive said second article.

In some versions said transfer unit comprises an actuation device arranged to move said first transfer element and said second transfer element to a storage station in which said first transfer element and said second transfer element are arranged to release said first article and said second article on said conveyor.

In some versions, the actuation device is mounted on said transfer unit and is configured to jointly move said first and said second transfer element.

In some versions, the actuation device comprises a first actuation element mounted on said first transfer element and intended to move the first transfer element and a second transfer element mounted on said second transfer element and intended to move said second transfer element.

Preferably said conveyor is movable along a transport direction at a transport speed.

In some versions, said transfer unit comprises an actuation device configured to move said first transfer element and said second transfer element in said storage station along a chasing trajectory with a chasing speed having a component in the storage station with the same direction as the transport speed. In some versions, said chasing speed has a modulus comprised between about ±40%, preferably between about ±20%, most preferably between about ±10% of the transport speed modulus. This thereby improves the positioning of the first and the second article on the conveyor, preventing them from being subject to breakage or tearing.

In some versions, said chasing speed has a component in the storage station with the same direction as the transport speed and smaller modulus than the transport speed modulus.

In some versions, said chasing speed has a component in the storage station with the same direction as the transport speed and modulus essentially equal to the transport speed modulus. This thereby minimizes or eliminates the t-component of the impact force of the article on the conveyor parallel to the transport speed.

In some versions, said chasing speed is parallel to said transport speed in said storage station, preferably said tracking speed is parallel to said transport speed in the path between the receiving station and the discharge station.

Preferably, said chasing speed has, in the storage station, a modulus comprised between about 2 m/sec and about 3 m/sec, preferably about 2.2 m/sec and 2.8 m/sec, most preferably about 2.4 m/sec.

Preferably said transport speed has a modulus comprised between about 2 m/sec and about 3 m/sec, preferably about 2.2 m/sec and 2.8 m/sec, most preferably about 2.4 m/sec.

Preferably the rotation unit is configured to rotate said first transfer element so that in said rotation from said support configuration to said discharge configuration said first abutment structure pushes said first article towards said conveyor.

Preferably the rotation unit is configured to rotate said second transfer element so that in said rotation from said support configuration to said discharge configuration said second abutment structure pushes said second article towards said conveyor.

Thereby, the first article and/or the second article are released from the first transfer element and the second transfer element, respectively, and fall from the transfer unit with a greater acceleration with respect to the acceleration of gravity. Such an expedient allows to improve the positioning of the article on the conveyor. Such an effect is particularly evident in the event of articles comprising bags made of flexible material. Furthermore, if the bags contain flowable material, this improves the distribution of the flowable material inside the bag, easing a homogeneous distribution of the flowable material inside the bag. This therefore contributes to obtaining a bag with a regular shape, i.e., with minimal height differences in the extension thereof, and thus easier to handle in the subsequent transformation operations. Such an expedient further allows to speed up the transfer operations of the articles. In fact, the first article and/or the second article are almost immediately released from the first transfer element and from the second transfer element, respectively, and it is thus possible almost immediately to move the first transfer element and the second transfer element from the storage station to the first and/or the second receiving station,

In some embodiments, the rotation unit is configured to rotate said first transfer element and/or said second transfer element so that, in said discharge configuration, said first abutment structure imposes a thrust on said first article with a force such as to accelerate the fall of the article. The modulus of the thrust force is appropriately calibrated, e.g., as a function of the type of article, so as to push the latter onto the conveyor without damaging it.

In some versions, the rotation unit is configured to rotate said first transfer element and/or said second transfer element between said support configuration and said discharge configuration by a rotation angle of ≥90°, preferably ≥120°preferably by a rotation angle of about 180°.

By varying the rotation angle and/or the rotation speed of the first transfer element and/or the second transfer element, and/or the thrust force of the first abutment structure and/or the second abutment structure, it is possible to increase or decrease the impact force of the first and/or the second article on the conveyor. This improves the positioning of the articles on the conveyor and the distribution of the product inside the bag.

In some versions, the first transfer element can be configured in a transport configuration in which said first support structure is arranged with an angle of inclination with respect to the horizontal plane which is lower with respect to the angle of inclination in the support configuration. Preferably in said transport configuration, said first support structure is positioned so as to define a horizontally arranged first support plane.

In some versions, the second transfer element can be configured in a transport configuration in which said second support structure is arranged with an angle of inclination with respect to the horizontal plane which is lower with respect to the angle of inclination in the support configuration. Preferably in said transport configuration, said second transport structure is positioned so as to define a horizontally arranged second support plane.

By rotating the first and/or the second transfer element in the transport configuration, the positioning of the first article and/or the second article on the transfer unit can be improved. Accidental dropping of the first and/or the second article during the movement towards the storage station can also be avoided at high movement speeds.

In some versions, the rotation unit is configured to rotate said first transfer element and/or said second transfer element from said support configuration to said transport configuration and subsequently rotate said first transfer element and/or said second transfer element from said transport configuration to said release configuration.

Preferably said rotation from said support configuration to said transport configuration is provided in the movement from said receiving station or from said second receiving station towards said storage station.

Preferably said rotation from said transport configuration to said release configuration is provided in said storage station.

Preferably said rotation from said transport configuration to said release configuration is provided in the movement from said receiving station or from said second receiving station towards said storage station.

In one version, it is provided to rotate the first and/or the second transfer element from the support configuration to said transport configuration, and subsequently from said transport configuration to said release configuration.

In some versions said rotation unit comprises a first rotation element mounted on said first transfer element and movable therewith and intended to rotate said first transfer element, and a second rotation element mounted on said second transfer element and movable therewith and intended to rotate said second transfer element.

In other versions, said rotation unit comprises a rotation element mounted on said transfer unit and movable therewith and intended to rotate said first transfer element and said second transfer element.

In some versions said rotation unit is configured to rotate said first transfer element along a third rotation direction opposite said first rotation direction to move it from said discharge configuration to said support configuration, and to rotate said second transfer element along a fourth rotation direction opposite the second rotation direction to bring it from said discharge configuration to said support configuration. It is thereby possible to rotate the first transfer element and the second transfer element to bring them back to the support configuration.

In some versions, an adjustment device is provided to adjust the inclination of said first support structure and/or said second support structure in said support configuration.

Preferably the first transfer element is ‘L’-shaped.

Preferably, the first transfer element is configured so as to define a single housing seat for at least one article.

Preferably, the first transfer element comprises a single support structure from which a single abutment structure is extended so as to define a single housing seat of the first transfer element. This allows to improve the positioning of at the least one article in the housing seat and above all to improve the positioning of the at least one article on the conveyor. The adjustment of the rotation of the first transfer element in the discharge configuration can be optimized.

Preferably, the second transfer element is ‘L’-shaped.

Preferably, the second transfer element is configured so as to define a single housing seat for at least one article.

Preferably, the second transfer element comprises a single support structure from which a single abutment structure is extended so as to define a single housing seat of the second transfer element. This allows to improve the positioning of at the least one article in the housing seat and above all to improve the positioning of the at least one article on the conveyor. The adjustment of the rotation of the first transfer element in the discharge configuration can be optimized.

Such a configuration allows to optimize the adjustment of the thrust of the article on the conveyor. The first and/or the second transfer element are configured so that no housing seat is defined for an article in the discharge configuration. In other words, it is necessary to rotate the first and/or the second transfer element to bring them into the receiving configuration so that another article can be loaded. Therefore, it is not necessary to adjust the rotation of the first and/or the second transfer element in the discharge configuration so as to define a new receiving position, and this allows the rotation angle and/or the rotation speed to be adjusted solely based on the features of the article to be deposited.

In some versions, an adjustment element is provided for adjusting the distance between said first support structure and said second support structure. It is thereby possible to transfer articles of different sizes with the transfer unit of the invention.

In some versions said conveyor is of the belt type defining a transport plane for said first article and said second article. The belt conveyor can be formed by a continuous belt or by a plurality of rollers rotating about respective rotation axes parallel to each other and jointly defining the transport plane for said first article and said second article.

Preferably said conveyor is positioned so as to define a horizontal transport plane, said transport direction being directed parallel to a horizontal plane.

In some versions at least one of said first rotation axis and/or said second rotation axis is a horizontal rotation axis.

Preferably at least one of said first rotation axis and said second rotation axis is parallel to the transport plane of the conveyor.

In some versions, at least one of said first rotation axis and said second rotation axis has a projection on the transport plane of the conveyor which is perpendicular to the transport direction.

In some versions, at least one of said first rotation axis and said second rotation axis has a projection on the transport plane of the conveyor which is parallel to the transport direction.

In some versions, at least one of said first rotation axis and said second rotation axis is transverse with respect to the transport plane of the conveyor.

Preferably at least said first rotation axis and said second rotation axis are parallel to each other.

In some versions, said rotation unit comprises a first rotation element intended to rotate said first transfer element and a second rotation element intended to rotate said first transfer element.

In some versions, said actuation device is configured to move said first transfer element and said second transfer element from said storage station towards said first receiving station and/or said second receiving station with a return speed having a return speed component with a direction opposite the transport speed.

Preferably the return speed is parallel to the transport speed and has the opposite direction to the transport speed.

Preferably said return speed has a greater modulus with respect to the chasing speed modulus. This allows to speed up the operation of the transfer unit.

Preferably said return speed has a modulus comprised between about 2.5 m/sec and about 3.5 m/sec, preferably between about 2.7 m/sec and about 3.2 m/sec, most preferably about 3 m/sec.

In some versions, the actuation device is mounted on said transfer unit and is configured to jointly move said first and said second transfer element. In some versions, the actuation device comprises a first actuation element mounted on said first transfer element and intended to move the first transfer element and a second transfer element mounted on said second transfer element and intended to move said second transfer element.

In some versions separation elements are provided on the conveyor, defining a predefined first storage position for said first article and a predefined second storage position for said second article on said conveyor.

Preferably, the separation elements project from the conveyor plane towards said first support structure and said second support structure.

In some versions, said first transfer element comprises a first lead-in element positioned near the first abutment structure on the opposite side with respect to the first support structure and intended to facilitate the positioning of the first article in the first transfer element. The first lead-in element is diverging from the first support structure away therefrom.

In some versions said second transfer element comprises a second lead-in element positioned near the second abutment structure on the opposite side with respect to the second support structure and intended to facilitate the positioning of the second article in the second transfer element. The second lead-in element is diverging from the second support structure away therefrom.

Preferably, the first and/or the second lead-in element are erected from the first abutment structure and the second abutment structure, respectively.

In some versions said apparatus comprises a packaging unit intended to receive said first article and said second article from said conveyor and configured to package said first article and said second article in a single box.

Preferably, said preparation unit includes at least one feed belt for feeding said first article and said second article to said transfer unit.

The feed belt is movable along a feed direction, the projection of which on the transport plane is transverse and preferably perpendicular to said transport direction.

In some versions, said preparation unit comprises a pair of feed belts intended to feed said first article to said first transfer element and said second article to said second transfer element of said transfer unit, respectively.

In some versions, the first support structure comprises a second longitudinal edge facing said at least one feed belt and an opposite first longitudinal edge.

In some versions, the second support structure comprises a fourth longitudinal edge facing said at least one feed belt and an opposite third longitudinal edge.

In some versions, said first transfer element comprises a first blocking element which is transverse with respect to the first support structure and cooperating with said first support structure to prevent accidental falls of the first article from the first transfer element. The first blocking element is provided near the first longitudinal edge of the first support structure adjacent to the first proximal edge. The first blocking element is preferably extended from the first longitudinal edge of the first support structure.

In some versions said second transfer element comprises a second blocking element which is transverse with respect to the second support structure and cooperating with said second support structure to prevent accidental falls of the second article from the second transfer element. The second blocking element is provided near a third longitudinal edge of the second support structure adjacent to the second proximal edge. The second blocking element is preferably extended from the third longitudinal edge of the second support structure.

The presence of the first blocking element and/or the second blocking element allows to avoid accidental falls of the first article from the first transfer element or respectively the second article from the second transfer element. If, for example, at least one feed belt is actuated with such high forces that the first article and the second article could slide on the first support structure or respectively on the second support structure and fall therefrom, the first or respectively the second blocking element prevent such a fall.

In some versions, the first support structure is positioned so that the first longitudinal edge is at a lower vertical height with respect to the second longitudinal edge.

In some versions, the second support structure is positioned so that the third longitudinal edge is at a lower vertical height with respect to the fourth longitudinal edge.

This thereby favors the movement of the first article towards the first blocking element and the second article towards the second blocking element, respectively.

In some versions, the first support structure is positioned so that the first longitudinal edge is at a higher vertical height with respect to the second longitudinal edge.

In some versions, the second support structure is positioned so that the third longitudinal edge is at a higher vertical height with respect to the fourth longitudinal edge.

The positioning of the first and the second article on the first transfer element and on the second transfer element, respectively, is improved. In fact, this thereby eases the movement of the first article towards the first blocking element and the first abutment structure, and thus the positioning of the first article in a circumscribed zone of the first support structure. Similarly, the movement of the second article towards the second blocking element and the second abutment structure is eased, and thus the positioning of the second article in a circumscribed zone of the second support structure. In such a version, the first article tends to be positioned in the corner defined between the first support structure, first abutment structure and first blocking element, and similarly the second article tends to be positioned in the corner between the second support structure, second abutment structure and second blocking element.

Preferably, the first transfer element is in an advanced position with respect to the second transfer element in the transport direction F.

In some versions, said preparation unit comprises a filling hopper containing flowable material, and a bagging device for bagging said flowable material in at least one bag.

In some versions said transfer unit comprises a guide device for guiding said first transfer element and/or said second transfer element between said storage station and said receiving station.

In some versions said rotation comprises rotating said first transfer element along a first rotation direction to move it from said support configuration to said discharge configuration and rotating said second transfer element along a second rotation direction opposite the first rotation direction to bring it from said discharge configuration to said support configuration.

In some versions, the method provides to rotate said first transfer element and said second transfer element in a synchronized manner to bring them from said discharge configuration to said support configuration.

In some versions, said method provides to push said first article from said first transfer element towards said conveyor in said discharge configuration.

In some versions, said method provides to push said second article from said second transfer element towards said conveyor in said discharge configuration.

In some versions, said method comprises pushing said first article with a force such as to impart an acceleration greater than the acceleration of gravity to said first article in said discharge configuration.

In some versions, said method comprises pushing said second article with a force such as to impart an acceleration greater than the acceleration of gravity to said second article in said discharge configuration.

Preferably said rotation comprises rotating said first transfer element by a rotation angle ≥90°, preferably ≥120°, preferably ≥180° to move it between said support configuration and said discharge configuration.

Preferably said rotation comprises rotating said second transfer element by a rotation angle ≥90°, preferably ≥120°, preferably ≥180° to move it between said support configuration and said discharge configuration.

Preferably, said movement comprises moving said first transfer element with a chasing speed arranged parallel to said transport speed.

Preferably, said movement comprises moving said second transfer element with a chasing speed arranged parallel to said transport speed.

Preferably, said depositing comprises depositing said first article in a predefined first position on said conveyor.

Preferably, said depositing comprises depositing said second article in a predefined second position on said conveyor.

In some versions, said method comprises transporting said first article and said second article with said conveyor along said transport direction.

In some versions said method further comprises rotating said first transfer element along a third rotation direction which is opposite with respect to said first rotation direction to bring said first transfer element from said discharge configuration to said support configuration.

In some versions said method further comprises rotating said second transfer element along a fourth rotation direction which is opposite said second rotation direction to bring said second transfer element from said discharge configuration to said support configuration.

In some versions, said rotation comprises rotating said first transfer element and said second transfer element in a synchronized manner to bring them from the support configuration to the discharge configuration.

In some versions, it is provided to rotate said first and/or said second transfer element from said support configuration to said transport configuration during the movement from said second receiving station to said storage station.

In some versions said first and/or said second transfer element from said support configuration to said transport configuration during the movement from said receiving station to said storage station.

Preferably said method comprises simultaneously translating said first transfer element and said second transfer element from said storage station to said first receiving station and/or said second receiving station.

In some versions said further rotating is provided during said translation to bring said first transfer element and said second transfer element in said support configuration during the movement from said storage station.

In some versions, said method comprises translating said transfer unit towards a first receiving station to feed a first article onto said first transfer element and further translating said transfer unit towards a second receiving station to feed a second article onto said second transfer element.

In some versions, said method comprises translating said transfer unit towards a receiving station to feed a first article onto said first transfer element and further feed a second article onto said second transfer element.

In some versions, said method comprises adjusting the inclination of said first support structure and/or said second support structure in said support configuration.

Preferably said further feeding is provided after said feeding.

Preferably at least one of said first article and said second article comprises a bag containing loose material, e.g., flakes, or granular material.

Preferably at least one of said first article and said second article comprises a bag containing grains.

It should be specified that some steps of the methods described above may be independent of the order of execution reported. In addition, some steps may be optional. In addition, some steps of the methods may be performed repetitively, or may be performed in series or in parallel with other steps of the method.

### BRIEF DESCRIPTION OF THE DRAWINGS

The features and advantages of the invention will become clearer from the detailed description of a preferred embodiment thereof, shown by way of non-limiting example, with reference to the appended drawings, wherein:

FIG. 1 is an interrupted schematic view of a transfer unit according to the invention and a feed unit;

FIG. 2 is an interrupted schematic view of a transfer unit according to the invention in a first receiving station;

FIG. 3 is an interrupted schematic view of a transfer unit according to the invention in a second receiving station;

FIG. 3A is an interrupted enlarged view of the transfer unit of FIG. 3;

FIG. 4 is an enlarged schematic view of the transfer unit of FIG. 1 with some parts removed for clarity;

FIG. 4A is an enlarged schematic front view of the transfer unit of FIG. 4;

FIG. 5 is an interrupted schematic view of a transfer unit according to the invention in a storage station.

### DETAILED DESCRIPTION OF THE PREFERRED EMBODIMENTS

In the enclosed Figures, 1 globally refers to a transfer unit made in accordance with the present solution. The transfer unit 1 is configured to transfer a plurality of articles 2 from a preparation unit 201 to a conveyor 101 of a packaging unit which is intended to package the articles 2 in boxes. Such a packaging unit not shown in the Figures is preferably of the ‘wrap-around’ type, obtaining the packaging by wrapping a box around an article 1 to be packaged.

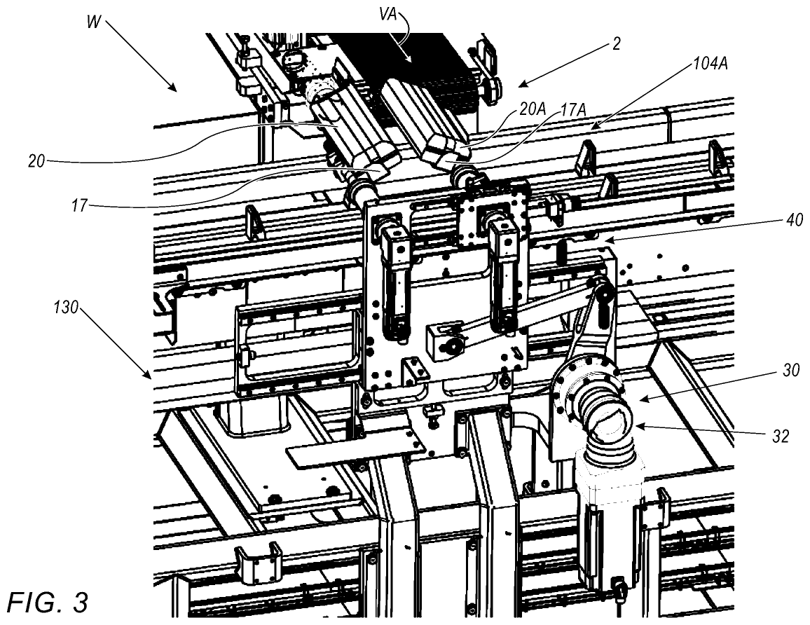

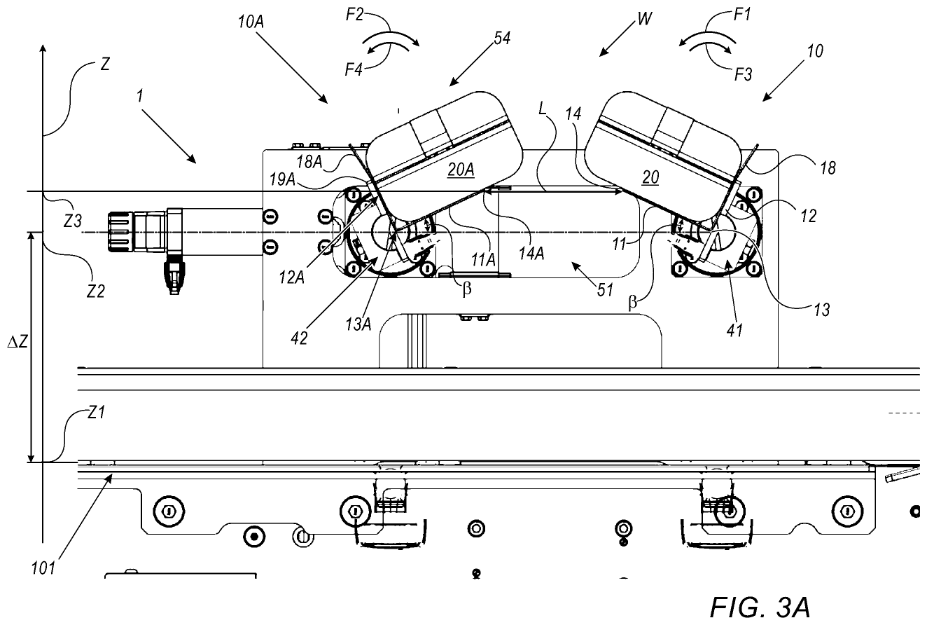

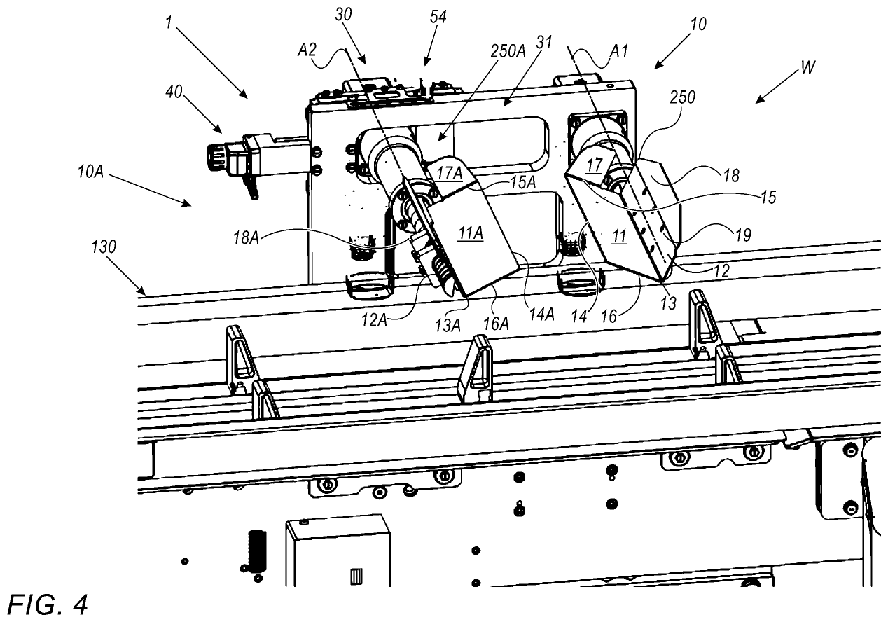

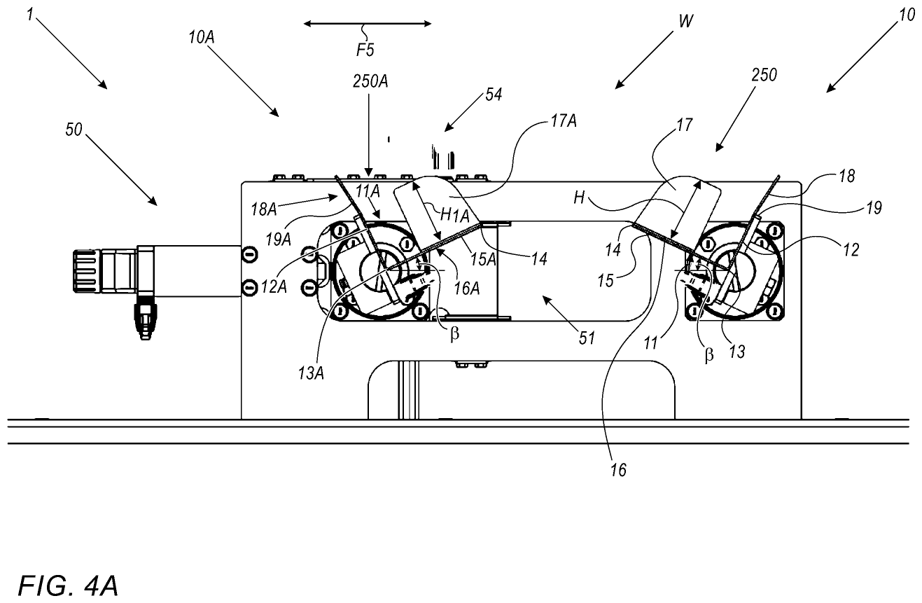

In the present example, the plurality of articles 2 comprises a first article 20, and a second article 20A, better seen in FIG. 3 or 4. In the present example, each article 20, 20A of the plurality of articles 2 consists of one or more flexible pouches, filled with predetermined quantities of flowable products in the form of a discrete particulate consisting of granules and/or flakes of grains and suitably sealed. In other versions not shown, the first and the second article may be of different types from bags of grains, and/or of different types and/or sizes from each other. In the version shown, the first article 20 and the second article 20A are of the same type. In other versions not shown, the first article 20 and the second article 20A are of a different type and/or size and/or shape from each other.

The preparation unit 201 comprises a filling and sealing plant 203 in which a flowable product is inserted in a pouch which is then sealed so as to form an article of the plurality of articles 2, and a feed belt 202 which receives the articles of the plurality of articles 2 from the filling and sealing plant 203 and moves them to an outlet section 204 of the feed belt 202 to feed the articles of the plurality of articles 2 to the transfer unit 1.

The feed belt 202 is arranged transversally with respect to the conveyor 101 and is movable along a feed direction Fa at a feeding speed Va. The feed direction Fa is oriented so that its projection on the conveyor 101 is transverse or preferably perpendicular to the transport direction F.

The packaging unit comprises the conveyor 101 which is formed by an endless belt arranged horizontally so as to define a horizontal transport plane and which transports the articles 2 along a transport direction F towards transformation devices provided downstream of the conveyor 101 and not shown in the Figures. The conveyor 101 is positioned at a lower vertical height Z1 with respect to the vertical height of the outlet section 204 of the feed belt 202. The conveyor 101 is driven at a transport speed VF having modulus M2.

The conveyor 101 is provided with a plurality of separation elements 110 which project from the plane of the conveyor 101 upwards and define a plurality of predefined storage positions for the articles of the plurality of articles 2 on the conveyor.

The transfer unit 1 comprises in its most general units a first transfer element 10 and a second transfer element 10A cooperating to support the first article 2, as better seen in FIGS. 3 and 3A.

The first transfer element 10 comprises a first support structure 11 intended to receive at least a first article 20, and a first abutment structure 12 extending from the first support structure 11 and arranged almost perpendicularly with respect to the first support structure 11. The first abutment structure 12 cooperates with the first support structure 11 to define, at least partially, a housing seat 250 for the first article 20.

The first support structure 11 has the shape of a flat slab delimited by a first proximal edge 13 from which the first abutment structure 12 extends, a first free edge 14 opposite the first proximal edge 13, a first longitudinal edge 15 and a second longitudinal edge 16. The first longitudinal edge 15 and the second longitudinal edge 16 extend along the transport direction F, the second longitudinal edge 16 faces the outlet section 204 of the feed belt 202, while the first longitudinal edge 15 is provided on the opposite side with respect to the outlet section 204 of the feed belt 202. The first proximal edge 13 is in an advanced position along the transport direction F with respect to the first free edge 14.

The first abutment structure 12 is also in the shape of a flat slab and comprises a first proximal edge adjacent to the first support structure 11 a first distal edge 19 provided on the opposite side with respect to the first support structure 11. The first transfer element 10 further comprises a first connecting portion 18 arranged transversally with respect to the first abutment structure 12 and extending from the first distal edge 19 towards the outside of the first transfer element 10, i.e., on the opposite side with respect to the housing seat 250 so as to define a lead-in element for the insertion of the first article 20 in the first transfer element 10 and to ease the fall of the first article 20 onto the first support structure 11.

The first connecting portion 18 is inclined at an angle comprised between 0°and 20°with respect to the first abutment portion 12.

The first transfer element 10 further comprises a first blocking element 17 extending from the first longitudinal edge 15 extending in a nearly vertical direction from the first support structure 11 and having a vertical extension H1 such as to allow to block the first article 20. The blocking element 17 allows to avoid accidental falls of the first article 2 from the first transfer element 10 as it is fed by the feed belt 202.

The second transfer element 10A is configured to house a second article 20A and is structurally similar to the first transfer element 10, therefore the corresponding parts will be indicated with corresponding numerical references and not described in detail.

The transfer unit 1 is configured so that the first abutment structure 12 and the second abutment structure 12A face each other and are arranged so that the first support structure 11 and the second support structure 11A are interposed therebetween.

The second transfer element 10A is arranged so that the second free edge 14A is in an advanced position along the transport direction F with respect to the second proximal edge 13A.

The transfer unit 1 further comprises, a bearing structure 31 on which the first transfer element 10 and the second transfer element 10A are mounted by means of a first arm 33 and a second arm 34, respectively, and which is slidingly fixed to a guide rail 130 and an actuation device 30 configured to move the first transfer element 10 and the second transfer element 10A along the guide rail 130 along the conveyor 101.

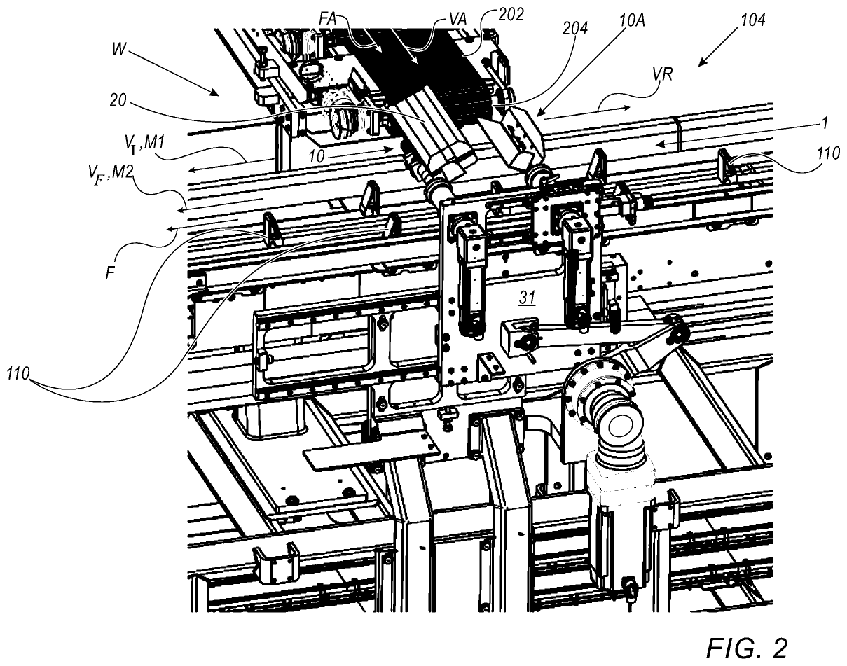

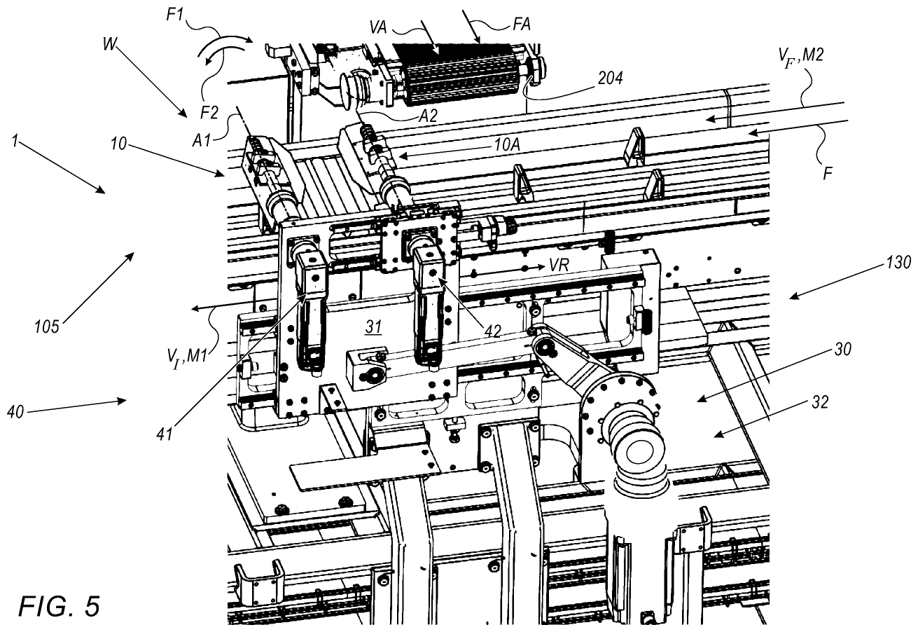

The actuation device 30 is mounted on the bearing structure 31. The actuation device 30 is configured to move the first transfer element 10 and the second transfer element 10A between a first receiving station 104, shown in FIG. 2, in which the first transfer element 10 faces the feed belt 202 so as to receive a first article 20 from the feed belt 202, a second receiving station 104A, shown in FIG. 3, in which the second transfer element 10A faces the feed belt 202 so as to receive a second article 20A from the feed belt 202, and a storage station 105, shown in FIGS. 5 and 5A, in which the first transfer element 10 and the second transfer element 10A are arranged to release the first article 20 and the second article 20A onto the conveyor 101.

In the first receiving station 104 and in the second receiving station 104A the first transfer element 10 and respectively the second transfer element 10A are positioned at the outlet section 204 of the feed belt 202. The first receiving station 104 is provided upstream of the second receiving station 104A along the transport direction F. The storage station 105 is provided in an advanced position with respect to the first receiving station 104 and the second receiving station 104A along the transport direction F.

The actuation device 30 is provided with an actuation motor 32 for moving the first transfer element 10 and the second transfer element 10A along a chasing trajectory with a chasing speed Vi with direction parallel to the transport speed VF and having in the storage station 105 modulus M1 roughly corresponding to modulus M2 of the transport speed VF.

Preferably, the actuation motor is arranged to move the first transfer element 10 and the second transfer element 10A with a chasing speed Vi having, in the storage station 105, a modulus comprised between about 2 m/sec and about 3 m/sec, preferably about 2.2 m/sec and 2.8 m/sec, most preferably about 2.4 m/sec.

Preferably the return speed Vr has a higher modulus with respect to the modulus of the chasing speed Vi, comprised between about 2.5 m/sec and about 3.5 m/sec, preferably between about 2.7 m/sec and about 3.2 m/sec, most preferably about 3 m/sec.

The actuation device 30 is configured to move the first transfer element 10 and the second transfer element 10A from the storage station 105 to the first receiving station 104 along a return trajectory with a return speed Vr parallel to the transport speed VF and having a direction opposite the transport speed VF.

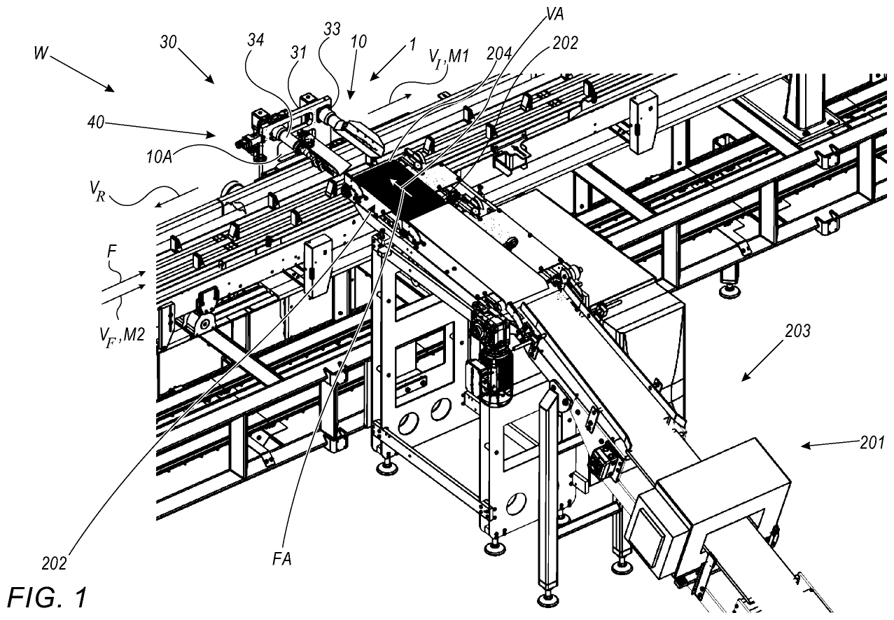

The transfer unit 1 further comprises a rotation unit 40 configured to rotate the first transfer element 10 about a first rotation axis A1 and the second transfer element 10A about a second rotation axis A2 to bring them from a support configuration W, shown in FIGS. 1-4, in which the first article 20 and the second article 20A can be supported by the first support structure 11 and the second support structure 11A to a discharge configuration W′, shown in FIG. 5, in which the first article 20 and the second article 20A are free to fall from the first transfer element 10 and the second transfer element 10A onto the conveyor 101.

In the support configuration W, the first support structure 11 and the second support structure 11A are arranged so as to define a support plane which is inclined with respect to a horizontal plane by an angle of inclination β of about 30°. The angle of inclination β is chosen based on the features of the first article 20 and the second article 20A to be transferred so that they can be stably supported by the first support structure 11 and the second support structure 11A, the angle of inclination β is preferably comprised between about 20°and 50°.

The first support structure 11 and the second support structure 11A are arranged so that the first free edge 14 is positioned at a greater vertical height with respect to the first proximal edge 13 and the second free edge 14A is positioned at a greater vertical height with respect to the second proximal edge 13A. Thereby, the first article 20 tends to be positioned on the first support structure 11 towards the first abutment structure 12 and the second article 20A on the second support structure 11A towards the second abutment structure 12A. As can be better seen in FIG. 3A, the first free edge 14 and the second free edge 14A are placed at the same vertical height Z3 and the first proximal edge 13 and the second proximal edge 13A are placed at the same vertical height Z2.

In the version shown, the first support structure 11 and the second support structure 11A are inclined by the same angle of inclination β, however, in other versions not shown, it is provided to arrange the first support structure 11 and the second support structure 11A at different angles of inclination from each other. Such versions are particularly useful when the first article 20 and the second article 20A are of different type, and/or shape, and/or size from each other.

The transfer unit 1 further comprises an adjustment element not shown in the Figures which is intended to adjust the angle of inclination of the first transfer element 10 and/or the second transfer element 10A.

In the version shown in the support configuration W, the first proximal edge 13 and the second proximal edge 13A are placed at the same vertical height Z2 which is lower with respect to the vertical height Z3 of the first free edge 14 and the second free edge 14A and higher than the vertical height Z1 of the conveyor 101, as shown in FIG. 3A.

The distance DZ between the first proximal edge 13 and the second proximal edge 13A and the conveyor 101 is such that the first transfer element 10 and the second transfer element 10A can rotate between the support configuration W and the discharge configuration W′ without hitting against the conveyor 101.

Furthermore, in the support configuration W, the first free edge 14 and the second free edge 14A are spaced by a distance L so as to ease the rotation of the first transfer element 10 and the second transfer element 10A.

The first rotation axis A1 is parallel to the second rotation axis A2. The first rotation axis A1 and the second rotation axis A2 are horizontal axes and are arranged so that their projection onto the conveyor 101 is perpendicular to the transport direction F.

The rotation unit 40 comprises a first rotation element 41 arranged to rotate the first transfer element 10 along a first rotation direction F1 and a second rotation element 42 arranged to rotate the second transfer element 10A along a second rotation direction F2 which is opposite the first rotation direction F1 to bring them from the support configuration W to the discharge configuration W′. The first rotation element 41 and the second rotation element 42 are mounted on the bearing structure 31.

The rotation unit 40 comprises a rotation motor, not shown in the Figures, operatively connected to the first rotation element 41 and the second rotation element 42 so as to rotate the first transfer element 10 and the second transfer element 10A in a synchronized manner to release the first article 20 and the second article 20A onto the conveyor 101.

In other versions not shown, the rotation unit 40 rotates the first transfer element 10 and the second transfer element 10A independently of each other. It is thereby possible to discharge, for example, the first article 20 and the second article 20A at different times and, therefore, in respective storage positions placed at a desired distance from each other or one above the other in the same storage position.

The rotation unit 40 is arranged to rotate the first transfer element 10 and the second transfer element 10A by a rotation angle greater than 90°, e.g., 180°. Thereby, in the discharge configuration W′ the first abutment structure 12 and the second abutment structure 12A impose a thrust on the article 200 towards the conveyor 101.

In some embodiments, the rotation unit 40 is arranged to rotate the first transfer element 10 and the second transfer element 10A for an angle equal to 360°.

The rotation unit 40 is arranged to rotate the first transfer element 10 and the second transfer element 10A between said support configuration and said discharge configuration with a rotation speed comprised between about 50 rad/sec and about 80 rad/sec, preferably about 70 rad/sec. The rotation unit 40 is arranged to rotate the first transfer element 10 and the second transfer element 10A so as to impose on the first transfer element 20 and the second transfer element 20A a thrust towards the conveyor. Thereby the first article 20 and the second article 20A fall onto the conveyor with an acceleration greater than the acceleration of gravity.

The transfer unit 1 further comprises an adjustment device 50 intended to adjust the distance between the first transfer element 10 and the second transfer element 10A and in particular between the first free edge 14 and the second free edge 14A. The adjustment device 50 comprises a slot 51 defined in the bearing structure 31 in which the first arm 33 of the first transfer element 10 is slidably housed.

The arm 33 can be moved in the slot 51 in either direction of the adjustment arrow F5 to vary the distance between the first free edge 14 and the second free edge 14A and thus vary the dimensions of the first housing seat 250 and the second housing seat 250A defined by the first transfer element 10 and the second transfer element 10A. It is thereby possible to transfer articles of different sizes with the transfer unit 1.

The adjustment device 50 further comprises a blocking element 54 for blocking the first transfer element 10 in the desired position with respect to the slot 51.

The rotation unit 40 is also arranged to rotate the first transfer element 10 along a third rotation direction F3 which is opposite the first rotation direction F1 and to rotate the second transfer element 10A along a fourth rotation direction F4 which is opposite the second rotation direction F2 to bring them from the discharge configuration W′ to the support configuration W.

The rotation unit 40 further comprises an adjustment device, not shown in the Figures, for adjusting at least one of rotation speed, rotation angle of the first transfer element 10 and/or the second transfer element 10A.

In operation, a first article 20 and a second article 20A are prepared in the filling and sealing plant 203, discharged onto the feed belt 202 and moved with a speed Va to the outlet section 204 of the feed belt 202.

By means of the actuation device 30, the transfer unit 1 is placed in the first receiving station 104 so that the first transfer element 10 is positioned at the outlet section 204 of the conveyor belt 202 and the first article 20 in output from the conveyor belt 202 can be received in the first housing seat 250, as shown in FIG. 2.

Subsequently, the transfer unit 1 is placed in the second receiving station 104A so that the second transfer element 10A is positioned at the outlet section 204 of the conveyor belt 202 and the second article 20A in output from the conveyor belt 202 can be received in the second seat 250A, as shown in FIG. 3.

Furthermore, in the first receiving station 104 and the second receiving station 104A, the transfer unit 1 is positioned so that the second longitudinal edge 16 and the fourth longitudinal edge 16A are positioned at a lower vertical height Z2 with respect to the outlet section 204 of the feed belt 202.

The first article 20 and the second article 20A are ejected from the feed belt at the speed Va to allow the first article 20 and the second article 20A to have a reach such that they fall onto the transfer unit 1 and are received in the first 250 seat defined by the first transfer element 10 and the second seat 250A defined by the second transfer element 10A, respectively. The first blocking element 17 and the second blocking element 17A provided in an opposite position to the outlet section 204 of the feed belt 202 act as limit switch elements for the first article 20 and the second article 20A, respectively, preventing them from falling from the first seat 250 and the second seat 250A, respectively, when falling from the feed belt 202.

In the fall towards the first seat 250 the first article 20 is guided by the first connecting portion 18 and in the fall towards the second seat 250A the second article 20A is guided by the second connecting portion 18A.

In the transfer unit 1, the first article 20 is positioned so as to be supported by the first support structure 11 and abutted by the first abutment structure 12, the second article 20A is positioned so as to be supported by the second support structure 11A and abutted by the second abutment structure 12A, as shown in FIGS. 3 and 3A. The first article 20 and the second article 20A are positioned in a predefined zone of the first support structure 11 and the second support structure 11A, respectively. Therefore, the position of the first article 20 and the second article 20A in transfer unit 1 is adjusted.

Subsequently, the transfer unit 1 is moved by means of the movement device 30 along the transport direction F with a chasing speed Vi parallel to the transport speed VF up to a discharge station 105 provided at a predefined storage position defined on the conveyor 101.

During such movement, the rotation unit 40 also rotates the first transfer element 10 and the second transfer element 10A to bring them from the support configuration W to a transport configuration not shown in the Figures in which the first support structure 11 and the second support structure 11A are arranged along a horizontal plane.

In other embodiments not shown, the rotation unit 40 rotates the first transfer element 10 and the second transfer element 10A to bring them into a transport configuration in which the first support structure 11 and the second support structure 11A are inclined with respect to a horizontal plane by an angle of inclination which is lower with respect to the angle of inclination in the support configuration W. This allows to prevent the first and second the article, during the transport towards the storage station 105, from tipping over or falling from the transfer unit. It is therefore not necessary to limit the speed at which the transfer unit moves towards the storage station.

Thanks to the configuration of the first transfer element 10 and the second transfer element 10A, it is possible to position the first article 20 and the second article 20A on the conveyor belt 101 in a precise storage position. It is possible to position the first article 20 and the second article 20A at a predefined distance from each other on the conveyor 101, and this allows to improve the packaging of the first article 20 and the second article 20A in a box.

In the storage station 105, the rotation unit 40 rotates the first transfer element 10 and the second transfer element 10A to bring them from the transport configuration to the release configuration W′ in which the first article 20 and the second article 20A are no longer constrained by the first support structure 11 and the second support structure 11A, respectively, and are free to fall onto the conveyor 101.

In such a rotation, the first support structure 11 and the second support structure 11A are rotated so that the first article 20 and the second article 20A are no longer supported and can fall from the transfer unit 1.

In the rotation from the transport configuration to the discharge configuration W′ the first abutment structure 12 and the second abutment structure 12A exert a certain force on the first article 20 and the second article 20A, respectively, so as to push the first article 20 and the second article 20A towards the conveyor 101. The modulus of the thrust force in the discharge configuration W′ depends on the angular rotation speed of the first transfer element 10 and the second transfer element 10A, respectively, and the amplitude of the rotation angle. By rotating the transfer unit 1, the first article 20 and the second article 20A are released from the first support structure 11 and the second support structure 11A, respectively, and pushed towards the conveyor 101 so that they fall towards the conveyor with an acceleration greater than the acceleration of gravity. The modulus of the thrust force is chosen based on the features of the supporting articles.

In the discharge station 105, the first transfer element 10 and the second transfer element 10A move at approximately the same speed as the conveyor 101 so that the relative motion between the conveyor 101 and the first transfer element 10 and the second transfer element 10A along the transport direction F is approximately zero.

Furthermore, in the discharge station 105 the first transfer element 10 and the second transfer element 10A are in the discharge configuration W′ and the first article 20 and the second article 20A are pushed towards the conveyor 101.

The provision of such a together with the minimization of the relative motion between conveyor 101 and first transfer element 10 and second transfer element 10A along the transport direction F allows to optimize the positioning of the first article 20 and the second article 20A on the conveyor 101.

After releasing the first article 20 and the second article 20A, the first transfer element 10 and the second transfer element 10A are led by means of the actuation device 30 back towards the first receiving station 104. In the movement from the discharge station 105 to the first receiving station 104, the rotation unit 40 rotates the first transfer element 10 and the second transfer element 10A from the discharge configuration W′ back to the support configuration W, so that the transfer unit 1 is ready to receive other articles in output from the feed belt 202.

In other versions not shown in the Figures, a single receiving station may be provided in which a first article 20 and a second article 20A are fed on the transfer unit 1. In such versions, for example, a single feed belt configured to feed two articles side-by-side can be used, alternatively two feed belts can each be used to feed one article onto the transfer unit.

In each case, the transfer unit provided with the first article 20 and the second article 20A is moved towards the storage station 105 in which the first article 20 and the second article 20A are deposited on the conveyor 101.

In other versions not shown in the Figures, the first support structure 11 is positioned so that the first longitudinal edge 15 is at a lower vertical height with respect to the second longitudinal edge 16 and the second support structure 11A is positioned so that the third longitudinal edge 15A is at a lower vertical height with respect to the fourth longitudinal edge 16A. Thereby, the first article 20 tends to position itself towards the first blocking element 17 and towards the first abutment structure 12 and the second article 20A tends to position itself towards the second blocking element 17A and towards the second abutment structure 12A. In such versions the first article 20 tends to be positioned in the corner defined between first support structure 11, first abutment structure 12 and first blocking element 17, similarly the second article 20A tends to be positioned in the corner between second support structure 11A, second abutment structure 12A and second blocking element 17A.

Therefore, the portion of the first support structure 11 and respectively the second support structure 11A on which the first article 20 and the second article 20A can be placed is thereby further limited.

The positioning of the first article 20 and the second article 20A on the first support structure 11 and the second support structure 11A is further adjusted; moreover in such a version it is possible to reduce the ejection speed of the first article 20 and the second article 20A.

In other versions not shown in the Figures, the first support structure 11 is positioned so that the first longitudinal edge 15 is at a higher vertical height with respect to the second longitudinal edge 16 and the second support structure 11A is positioned so that the third longitudinal edge 15A is at a higher vertical height with respect to the fourth longitudinal edge 16A. It is thereby possible to improve the positioning of the first article 20 and the second article 20A on the first support structure 11 and the second support structure 11A, respectively, thus avoiding accidental falls of the first and/or second article in the event of, for example, excessively high feed rates and thus imperfectly calibrated fall trajectories.

1. A transfer unit for transferring articles, the transfer unit comprising:
a first transfer element provided with at least a first support structure and a first abutment structure, wherein the first support structure defines a first support plane and the first abutment structure defines a first abutment plane transverse to the first support plane, wherein said first abutment structure cooperates with said first support structure to define a housing seat for a first article;
a second transfer element provided with at least a second support structure and a second abutment structure, wherein the second support structure defines a second support plane and the second abutment structure defines a second abutment plane transverse to the second support plane, wherein said second abutment structure cooperates with said second support structure to define a housing seat for a second article;
a conveyor adapted to receive said first article and said second article from said first transfer element and from said second transfer element, wherein the conveyor is positioned at a vertical height lower than said first support structure and said second first support structure,
a rotation unit configured to rotate said first support structure about a first rotation axis from a support configuration in which said first article is supported by the first support structure to a discharge configuration in which said first article is free to fall from said first transfer element onto said conveyor and to rotate said second support structure about a second rotation axis from a support configuration in which said second article is supported by the second support structure to a discharge configuration in which said second article is free to fall from said second transfer element onto said conveyor,
wherein, in said support configuration, said first support structure and said second support structure are inclined with respect to a horizontal plane so as to ease the movement of said first article and of said second article respectively towards said first abutment structure and said second abutment structure.

2. The transfer unit according to claim 1, wherein the first support structure comprises a first proximal edge arranged towards or adjacent to the first abutment structure and a first free edge opposite the first proximal edge, wherein in said support configuration said first proximal edge is arranged at a first vertical height lower than said first free edge, and wherein the second support structure comprises a second proximal edge arranged towards or adjacent to the second abutment structure and a second free edge opposite the second proximal edge, wherein in said support configuration said second proximal edge is arranged at a second vertical height lower than said second free edge.

3. The transfer unit according to claim 1, wherein in said support configuration at least one of said first support structure or said second support structure is inclined with respect to the horizontal plane respectively by a first angle of inclination and a second angle of inclination of at least 10°.

4. The transfer unit according to claim 1, wherein in said support configuration said first support structure and said second support structure are adjacent to each other and said first abutment structure and said second abutment structure are positioned on opposite sides with respect to said first support structure and said second support structure.

5. The transfer unit according to claim 1, wherein said rotation unit is configured to rotate said first transfer element along a first rotation direction to bring said first transfer element from said support configuration to said discharge configuration and wherein said rotation unit is configured to rotate said second transfer element along a second rotation direction opposite the first rotation direction to bring said second transfer element from said support configuration to said discharge configuration.

6. The transfer unit according to claim 1, further comprising, an actuation device configured to translate said first transfer element and said second transfer element between a first receiving station and a second receiving station, wherein said first transfer element is arranged to receive said first article at said first receiving station and a second receiving station said second transfer element is arranged to receive said second article at said second receiving station.

7. The transfer unit according to claim 1, wherein said conveyor is movable along a transport direction at a transport speed, and wherein said actuation device is configured to move said first transfer element and said second transfer element to a storage station along a chasing trajectory with a chasing speed, wherein said chasing speed in the storage station has a component with the same direction as the transport speed and modulus between ±40% of the modulus of the transport speed.

8. The transfer unit according to claim 7, wherein said actuation device is configured to move said first transfer element and said second transfer element to said storage station with a chasing speed, wherein said chasing speed in the storage station has a component with the same direction as the transport speed and modulus equal to the modulus of the transport speed.

9. The transfer unit according to claim 1, wherein said rotation unit is configured to rotate said first transfer element and said second transfer element such that in said rotation from said support configuration to said discharge configuration at least one of said first abutment structure or said second abutment structure pushes said first article and said second article, respectively, towards said conveyor.

10. A method for transferring articles, onto a conveyor, the method comprising:
arranging a first transfer element provided with at least a first support structure and a first abutment structure, wherein said support structure defines a first support plane and said first abutment structure defines a first abutment plane transverse to the first support plane, wherein the first abutment structure cooperates with said first support structure to define a housing seat for a first article;
arranging a second transfer element provided with at least a second support structure and a second abutment structure, wherein said second support structure defines a second support plane and said second abutment structure defines a second abutment plane transverse to the second abutment structure, wherein said second abutment structure cooperates with the second support structure to define a housing seat for a second article;
positioning said first transfer element and said second transfer element in a respective support configuration wherein said first support structure and said second support structure in said support configurations are inclined with respect to a horizontal plane so as to ease the movement of said first article and of said second article respectively towards said first abutment structure and said second abutment structure,
feeding said first article and said second article respectively on said first support structure and said second support structure,
rotating said first support structure about a first rotation axis and said second support structure about a second rotation axis from said support configuration in which said first article and said second article are supported respectively by said first support structure and said second support structure to a discharge configuration in which said first article and said second article are free to fall respectively from said first transfer element and said second transfer element onto a conveyor lying below the first transfer element and the second transfer element.

11. The method according to claim 10, wherein said rotating comprises rotating said first transfer element along a first rotation direction to move said first transfer element from said support configuration to said discharge configuration and rotating said second transfer element along a second rotation direction opposite the first rotation direction to bring said second transfer element from said support configuration to said discharge configuration.

12. The method according to claim 10, wherein said first transfer element and said second transfer element are rotated in a synchronized manner to bring said first and second transfer elements from said support configuration to said discharge configuration.

13. The method according to claim 10, further comprising, actuating said conveyor with a transport speed along a transport direction and moving said first transfer element with a chasing speed towards a storage station intended to store said first article and said second article wherein said chasing speed in the storage station has a component with the same direction as the transport speed and modulus equal to the modulus of the transport speed.

14. The method according to claim 13, wherein in said discharge configuration it is provided to push said first article and said second article towards said conveyor.

15. The method according to claim 10, further comprising rotating said first transfer element along a third rotation direction opposite said first rotation direction and rotating said second transfer element along a fourth rotation direction opposite said second rotation direction to respectively bring said first transfer element and said second transfer element from said discharge configuration to said support configuration.

16. The method according to claim 10, further comprising, translating said first transfer element and said second transfer element to a first receiving station and feeding said first article on said first transfer element and translating said first transfer element and said second transfer element to a second receiving station and feeding said second article onto said second transfer element.

17. The method according to claim 10, further comprising moving said first transfer element and said second transfer element from a receiving station to a storage station, wherein at least one of said first article and said second article is fed onto said first transfer element or onto said second transfer element at said receiving station, wherein at least one of said first article and said second article is deposited on said conveyor at said storage station.

18. The method according to claim 17, wherein during said moving said first transfer element and said second transfer element are rotated from said support configuration to a transport configuration wherein said first support structure in said transport configuration is arranged so as to define a first support plane inclined with respect to a horizontal plane by an angle of inclination lower than said first angle of inclination, wherein said second support structure in said transport configuration is arranged so as to define a second support plane inclined with respect to a horizontal plane by an angle of inclination lower than said second angle of inclination, and wherein said first support structure and said second support structure can be arranged in said transport configuration so as to define a first support plane and a second support plane arranged horizontally.
